(19) United States
(12) Patent Application Publication
(10) Pub. No.: US 2006/0230858 A1
(43) Pub. Date: Oct. 19, 2006

(54) Shift lever device

(75) Inventor: Fumio Kurogane, Saitama (JP)

Correspondence Address: FOLEY AND LARDNER LLP;SUITE 500, 3000 K STREET NW, WASHINGTON, DC, 20007, US

(73) Assignee: FUJI KIKO CO., LTD.

(21) Appl. No.: 11/405,571

(22) Filed: Apr. 18, 2006

(30) Foreign Application Priority Data
Apr. 19, 2005 (JP) 2005-120466

(51) Int. Cl. G05G 9/00

(52) U.S. Cl. 74/473.1

(57) ABSTRACT

A shift lever device includes a housing fixed to a vehicle body, and a shift lever swingably supported on the housing. The shift lever includes a tubular member, a rod disposed in the tubular member and having a spring support portion at an axially intermediate part thereof, a spring support sleeve fixedly disposed in the tubular member and having a spring support surface at a lower end thereof, and a spring placed around the rod and between the spring support portion of the rod and the spring support surface of the spring support sleeve so as to urge the rod to lockingly engage at a lower end with the housing.

### BACKGROUND OF THE INVENTION

The present invention relates to a shift lever device for an automatic transmission of a vehicle and more particularly to a shift lever device having a rod axially movable for engagement with or disengagement from a stationary housing and a spring for urging the rod to lockingly engage the housing.

In recent years, an automatic transmission capable of changing a gear ratio automatically is widely used in automotive vehicles. There are two types of shift lever devices for changing a shift range of a shift lever for such an automatic transmission, i.e., a pull-rod type for changing the range under a condition where a rod axially movable for engagement with or disengagement from a stationary housing is pulled-up by pushing a knob button and a push-rod type for changing the range under a condition where the rod is pushed down by pushing the knob button.

An example of a pull-rod type shift lever device is disclosed in Unexamined Japanese Patent Publication No. 2002-283866. FIGS. 8A and 8B show a knob and its adjacent portion of such a pull-rod type shift lever device. Into a knob 101 is inserted a metallic pipe 102. The knob 101 has an integral resin pipe 103 disposed around the metallic pipe 102. Namely, the knob 101 and the metallic pipe 102 are joined together at a portion “A”. Into the metallic pipe 102 is inserted a rod 104 of a nearly cruciform section, and to an upper end of the rod 104 is connected a connecting portion 105c of a pull block 105. The pull block 105 is movable along a vertical guide hole (no numeral) of the knob 101 and has an upward inclined surface 105a and a downward inclined surface 105b. On the other hand, a knob button 106 is provided so as to be movable along a horizontal guide hole (no numeral) of the knob 101. The knob button 106 has a downward inclined surface 106a and an upward inclined surface 106b. The rod 104 has a spring support portion 104a of an increased outer diameter. A spring 107 is disposed between the spring support portion 104a and a stepped portion downward surface 101e of the knob 101 for urging the rod 104 downward.

The rod 104 is urged downward by the spring 107. When the knob button 106 is pushed into the knob 101, the pull block 105 is pulled upward against the bias of the spring 107 to make the shift lever swingable.

Since the spring 107 is accommodated in the metallic pipe 102, it is desired that the inner diameter of the stepped portion downward surface 101e is small. On the other hand, since the knob 101 needs be formed with a space for accommodating the connecting portion 105c of the pull rod 105 at the same place where the stepped portion down surface 101e is formed, there are restrictions on the size of the stepped portion lower surface 101e such that the inner diameter of the stepped portion lower surface 101e cannot be sufficiently small. The width “b” of the connecting portion 105c of the pull bock 105 shown in FIG. 8B is thus determined based on agreement between the above-described conflicting matters, resulting in that the area of the stepped portion downward surface 101e is not sufficiently large.

### SUMMARY OF THE INVENTION

Since the stepped portion downward surface 101e that serves as a spring support surface is provided to the knob 101, it cannot be checked whether the spring 107 functions properly unless the knob 101 is installed in place on the metallic pipe 102. Namely, while it can be checked at the time of assembly in a part maker for making the shift lever device whether the spring 107 functions properly under a condition where a tentative knob 101 is installed in place on the metallic pipe 102, a new drawback of the spring 107 may possibly be caused when a knob is actually installed at the time of assembly in a car maker after shipping since the area of the stepped portion downward surface 101e is not sufficiently large.

It is accordingly an object of the present invention to provide a shift lever device which is free from the above-noted problem.

According to an aspect of the present invention, there is provided a shift lever device comprising a housing, and a shift lever swingably supported on the housing, the shift lever including a tubular member having a recessed portion at an inner circumferential surface, a rod axially movably disposed in the tubular member and having a spring support portion, a spring placed around the rod and abuttingly engaged at one of opposite ends with the spring support portion so as to urge the rod to lockingly engage at a lower end with the housing, a knob connected to an end of the tubular member, a knob button movably installed on the knob and operatively connected to the rod to cause, when pushed, the rod to be pulled upward against the bias of the spring thereby disengaging the rod from the housing to make the shift lever swingable, and a spring support sleeve disposed within the tubular member for supporting the other of the opposite ends of the spring, the spring support sleeve having at an outer circumferential surface a projection that is engaged in the recessed portion of the tubular member.

According to another aspect of the present invention, there is provided a shift lever device for an automatic transmission of a vehicle comprising a housing fixed to a vehicle body, and a shift lever swingably mounted on the housing, the shift lever including a tubular member, a rod axially movably disposed in the tubular member and having a spring support portion at an axially intermediate part thereof, a spring support sleeve fixedly disposed in the tubular member and having a spring support surface at a lower end thereof, a spring placed around the rod and between the spring support portion of the rod and the spring support surface of the spring support sleeve so as to urge the rod to lockingly engage at a lower end with the housing.

### BRIEF DESCRIPTION OF THE DRAWINGS

FIGS. 1A and 1B show principal portions of a shift lever device according to a first embodiment of the present invention, wherein FIG. 1A is a front sectional view and FIG. 1B is a side sectional view;

FIG. 2 is a perspective view of a pull rod and a rod employed in the shift lever device of the first embodiment;

FIGS. 3A, 3B and 3C show a spring support sleeve employed in the shift lever device of the first embodiment, wherein FIG. 3A is a plan view, FIG. 3B is a front sectional view and FIG. 3C is a side sectional view;

FIGS. 4A and 4B are sectional views for illustrating operations of the shift lever device of the first embodiment;

FIG. 5 is an exploded perspective view of the shift lever device of the first embodiment;

FIGS. 6A and 6B are views similar to FIGS. 1A and 1B, respectively but show a shift lever device according to a second embodiment;

FIGS. 7A, 7B and 7C are views similar to FIGS. 3A, 3B and 3C, respectively but show a spring support sleeve employed in the second embodiment; and

FIGS. 8A and 8B are views similar to FIGS. 1A and 1B, respectively but show a prior art shift lever device.

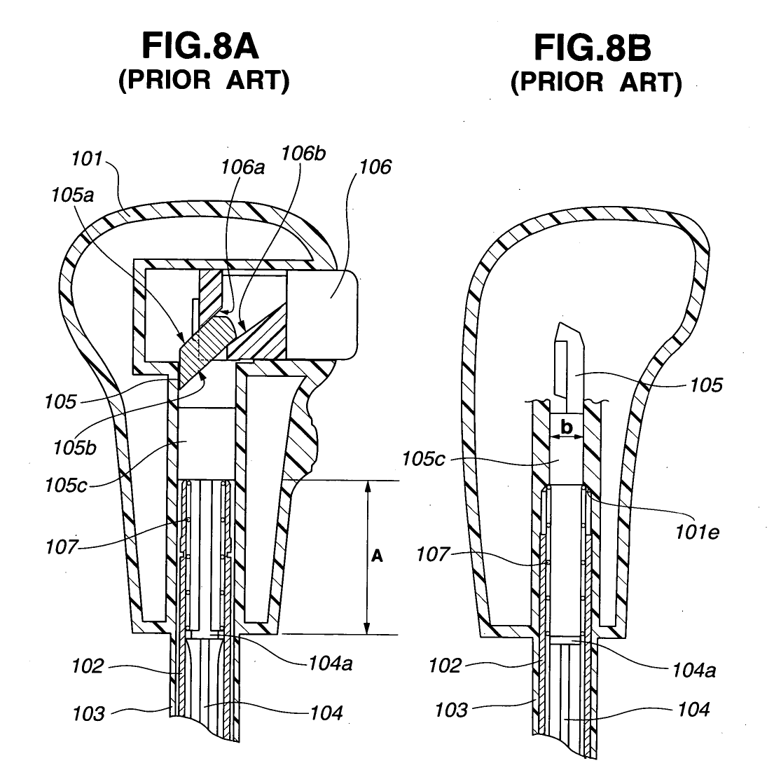

### DESCRIPTION OF THE PREFERRED EMBODIMENTS

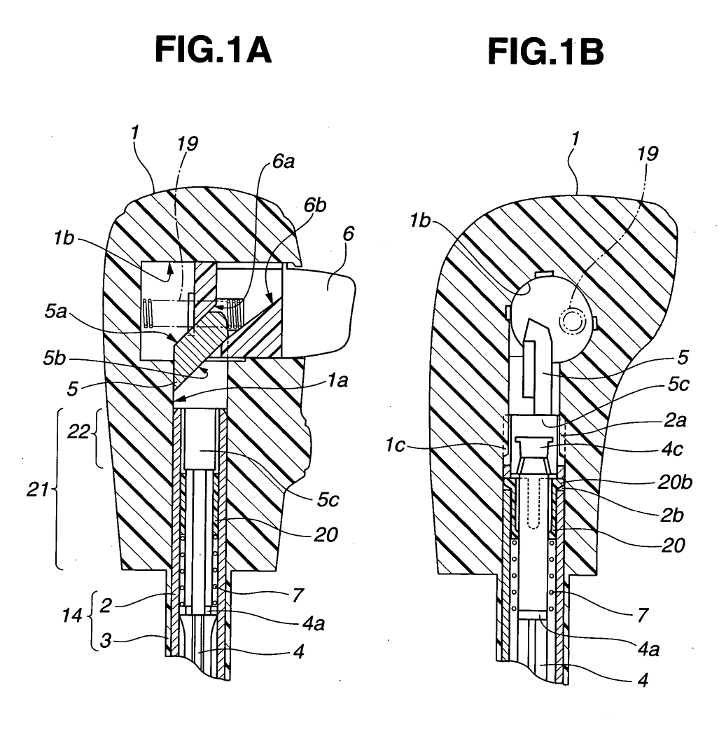

Referring to FIGS. 1A, 1B and 2 to 5 inclusive, a shift lever device according to a first embodiment of the present invention will be described.

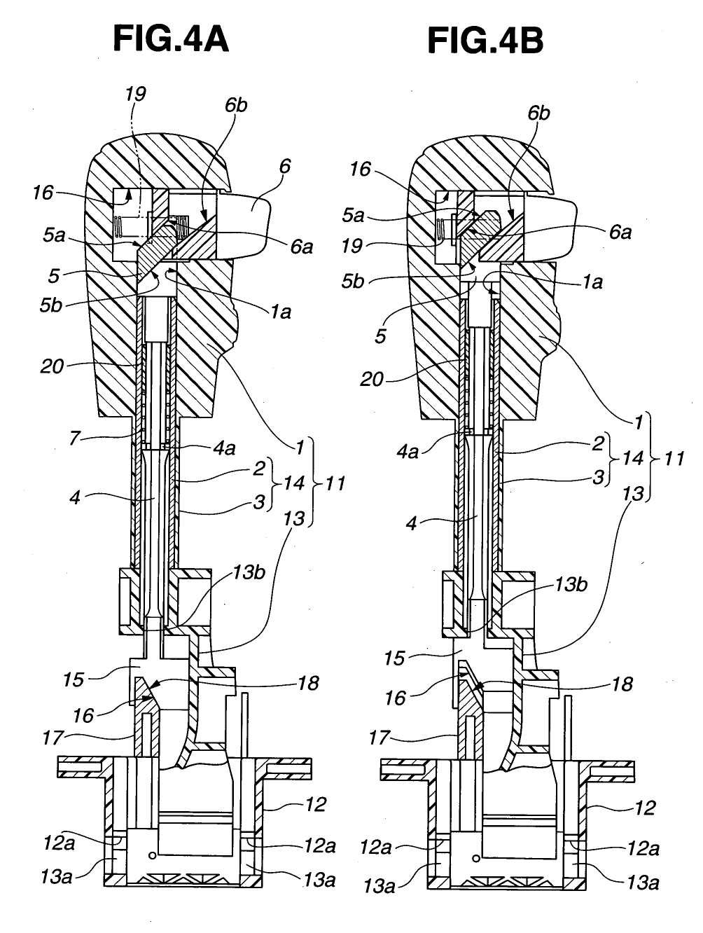

As shown in FIGS. 4A and 4B, the shift lever device includes a housing 12 and a shift lever 11 swingably mounted on the housing 12.

The shift lever 11 includes a shift lever base 13 swingably supported on the housing 12, a shift lever main body 14 mounted on the base 13 and a knob 1 mounted on an upper end portion of the shift lever main body 14.

The shift lever base 13 has at a lower end portion thereof an integral shaft 13a protruding horizontally therefrom in the opposite directions. The shaft 13a is rotatably supported by a pair of bearing portions 12a of the housing 12.

The shift lever main body 14 includes a metallic pipe or tubular member 2 and a resin pipe 3 covering the tubular member 2 and formed integral with the knob 1. A rod 4 made of resin is inserted into the tubular member 2 from the lower side of the shift lever base 13.

The knob 1 has a pull block 5 that is movable upward and downward along a first vertical guide hole 1a. Further, above the first guide hole 1a is formed a second guide hole 1b in a way as to extend horizontally in the direction to cross the first guide hole 1a at right angles. Slidably disposed within the second guide hole 1b is a knob button 6. A conversion means is provided for converting movement of the knob button 6 into vertical movement of the pull block 5. Namely, the pull block 5 has a pair of parallel upward and downward inclined surfaces, i.e., an upward inclined surface 5a and a downward inclined surface 5b. The knob button 6 has a downward inclined surface 6a and an upward inclined surface 6b which are in sliding contact with the upward and downward inclined surfaces 5a and 5b, respectively. Further, the knob button 6 has at an end portion an axial accommodation hole (no numeral), and between a bottom surface of the axial accommodation hole and a bottom surface of the second guide hole 1b is disposed a spring 19 for urging the knob button 6 outward.

As shown in FIG. 1A, the knob 1 is connected to an upper end portion of the tubular member 2 at a first connecting portion 21. To prevent relative rotation between the knob 1 and the tubular member 2, the upper end portion of the tubular member 2 has a plurality of axial slits 2a that are arranged in a circumferential direction, in which axial slits 2a are engaged protrusions 1c formed at the inner circumferential surface of the guide hole 1a of the knob 1.

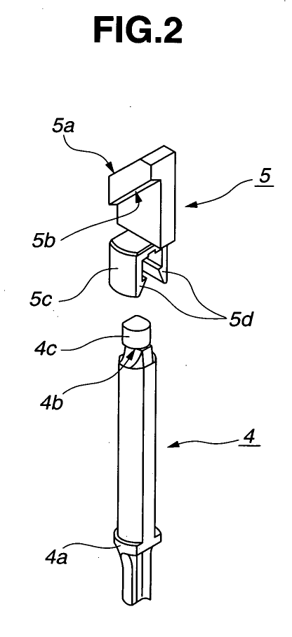

An upper end of the rod 4 inserted into the tubular member 2 is connected to the pull block 5 at a second connecting portion 22. The structure of the second connecting portion 22 will be described below. As shown in FIG. 2, the pull block 5 has at a lower part thereof an integral connection portion 5c. The connection portion 5c has a pair of hooks 5d, whereas the rod 4 has at an upper end thereof a head portion 4c formed with a pair of shelf-like engagement sections 4b. When the head portion 4c is placed between the pair of hooks 5d through movement in the direction perpendicular to the axis of the head portion 4c, the pair of shelf-like engagement sections 4b are engaged with the pair of hooks 5d such that the head portion 4c is held between the hooks 5d to allow the rod and the pull block 5 to move as an integral unit.

The structure for urging the rod 4 downward will be described. The rod 4 has a spring support portion 4a that is a portion increased in outer diameter. A spring 7 for urging the spring support portion 4a toward a base end portion of the shift lever 11 is disposed so as to surround the rod 4. For supporting the upper end of the spring 7, a spring support sleeve 20 is disposed inside the tubular member 2.

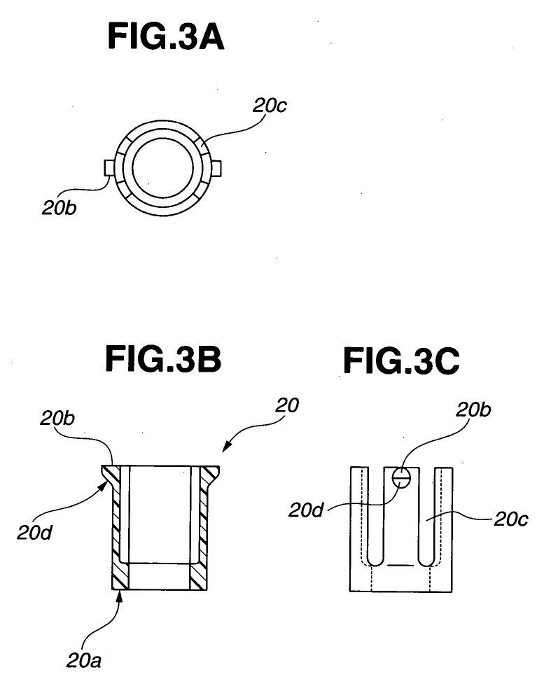

The spring support sleeve 20 is shown in an enlarged scale in FIGS. 3A to 3C. The spring support sleeve 20 is nearly hollow cylindrical and has a spring support surface 20a at a lower end. The spring support sleeve 20 has a pair of protrusions 20b for preventing movement thereof relative to the tubular member 2. The projections 20b are located closer to the knob 1, more specifically, closer to an upper part of the knob than the spring support surface 20a and at positions diametrically opposite to each other. On the other hand, the tubular member 2 has at the corresponding positions to the projections 20b a pair of recessed portions or holes 2b in which the projections 20b are fitted. For the purpose of making the spring support sleeve 20 be flexible or elastically deformable so that the spring support sleeve 20 can be inserted into the tubular member 2, the spring support sleeve 20 has four axial slits 20c arranged in the circumferential direction. Further, in order that the projections 20b can be inserted into the tubular member 2 with ease when the spring support sleeve 20 is pushed into the tubular member 2 while being elastically deformed, the projections 20b has a slanting lower surface 20d. Further, in order that the projections 20b are guided by the slits 2a into the holes 2b when the spring support sleeve 20 is inserted into the tubular member 2, the slits 2a of the tubular member 2 are disposed closer to the knob 1, more specifically, closer to an upper part of the knob 1 than the holes 2b and at circumferentially the same positions as the holes 2b.

The shift lever base 13 has a guide hole 13b for guiding up-and-down movement of the rod 4. To a lower end of the rod 4, which protrudes downward from the guide hole 13b is provided an operation portion 15. The operation portion 15 has a wedge-shaped groove at a lower side so as to form a detent engagement section 16 at a slanting surface of the wedge-shaped groove. On the other hand, the housing 12 has at a central portion thereof an integral detent plate 17 protruding upward. The detent plate 17 has a plurality of detent grooves 18 formed along an upper end thereof.

The detent grooves 18 includes a P range groove for parking, R range groove, N range groove, D range groove, 2 range groove and 1 range groove that are arranged adjacently one after another. An indicator cover (not shown) having an indication of the P range, etc. is disposed at an upper portion of the housing 12.

By pushing the knob button 6 against the bias of the springs 7 and 19 and thereby pulling the rod 4 upward by way of the upward inclined surface 6b and the downward inclined surface 5b, the detent engagement section 16 is disengaged from the detent grooves 18. This makes the shift lever 11 movable or swingable relative to the housing 12 for selection of the ranges.

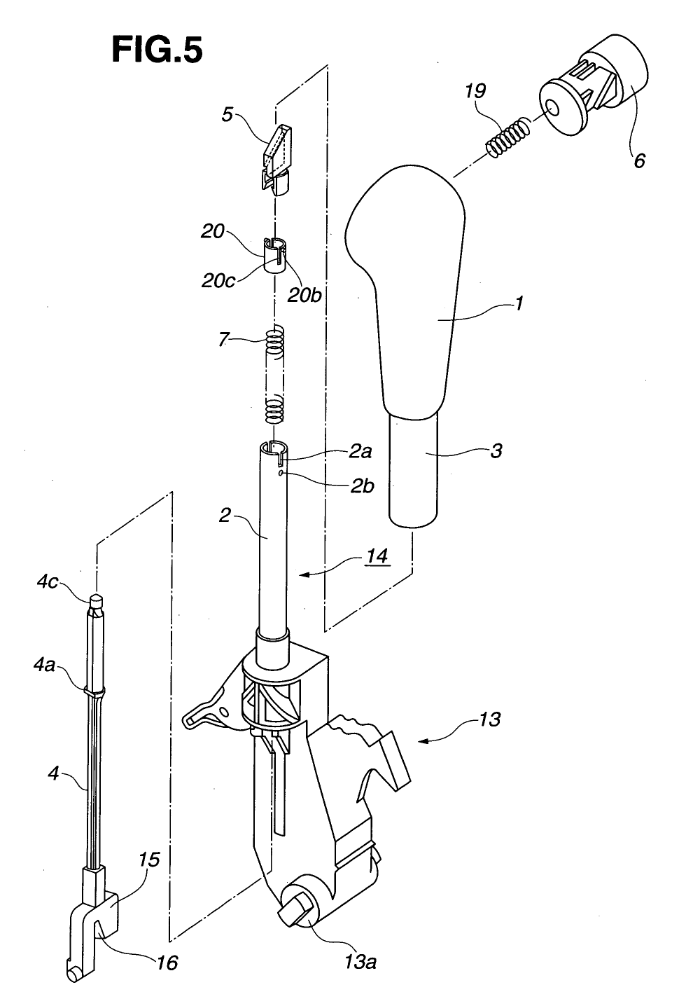

Then, assembly of the shift lever device will be described. As seen from FIG. 5, the rod 4 is inserted into the guide hole 13b of the shift lever base 13 from the lower side thereof. When the upper end of the rod 4 protrudes upward from the tubular member 2, the spring 7 is disposed within the tubular member 2 in a way as to surround the rod 4. Then, the spring support sleeve 20 is inserted into the tubular member 2 while compressing the spring 7. Thereupon, the protrusions 20b of the spring support sleeve 20 are brought into engagement with the holes 2b such that the spring support sleeve 20 is fixedly held within the tubular member 2. Thereafter, the rod 4 is pushed upward to cause the head 4c to protrude from the upper end of the tubular member 2. The head 4c of the rod 4 is placed between the pair of hooks 5d of the pull block 5 and engaged therewith through movement of the pull block 5 in the direction substantially perpendicular to the axis of the rod 4, whereby the pull block 5 and the rod 4 are joined together at the second joining portion 22 (refer to FIG. 1A). Thereafter, the second joining portion 22 is pulled into the tubular member 2 under the bias of the spring 7 and stops when the pull block 5 is abuttingly engaged with the upper end of the tubular member 2. After the shift lever 11 is swingably supported on the housing 12, the knob 1 is attached to the shift lever 11.

Then, the operation of the shift lever device will be described. First, in case the shift lever 11 is positioned in, for example, the P range, the rod 4 is urged downward under the bias of the springs 7 and 19 as shown in FIG. 4A, thus causing the detent engagement section 16 is engaged in the detent groove 18 for the P range.

For moving the shift lever 11 from the P range to the D range, the knob button 6 is pushed. Namely, as shown in FIG. 4B, the knob button 6 is pushed against the bias of the springs 7 and 19 and the pushing force is transmitted to the rod 4 by way of the upward inclined surface 6b and the downward inclined surface 5b, thus causing the rod 4 to be pulled upward and therefore causing the detent engagement section 16 to be disengaged from the detent groove 18. Thereafter, the shift lever 11 is moved and the knob button 6 is released from being pushed. By this, the rod 4 is urged downward by the springs 7 and 19 and the detent engagement section 16 is engaged in the detent groove 18 for the D range.

While only movement of the shift lever 11 from the P range to the D range has been described, movement of the shift lever 11 to other ranges can be attained by the similar operation as described above.

Since according to the present invention the spring support sleeve 20 that supports the knob side end or upper end of the spring 7 is disposed within the metallic tube 2, the knob side end of the spring 7 is assuredly supported by the spring support sleeve 20 irrespective of whether the knob 1 is attached to the end of the tubular member 2. For this reason, the spring 7 can be tested for its operation before the knob 1 is attached to tubular member 2, and therefore the shift lever device can be assured of its operation or performance.

Further, since according to the present invention the projections 20b formed on the outer circumferential surface of the spring support sleeve 20 for engagement in the slits 2a formed in the tubular member 2 are disposed closer to the knob 1 than the spring support surface 20a, the spring support surface 20a can be larger and can support the spring 7 more assuredly.

Further, according to the present invention, at the time of insertion of the spring support sleeve 20 into the tubular member 2, the projections 20a are aligned with the slits 2a of the tubular member 2 and moved along the same. Insertion of the spring support sleeve 20 is continued after the projections 20a once run on the inner circumferential surface of the tubular member 2, and then the projections 20b snap into engagement in the holes 2b. Namely, the slits 20a serve as guides for positioning the projections 20b. Thus, the projections 20b can be engaged in the holes 2b easily and assuredly, and therefore assembly of the shift lever device can be attained with an improved efficiency. The slits 2a also serve as a stopper for preventing rotation of the knob 1 relative to the tubular member 2.

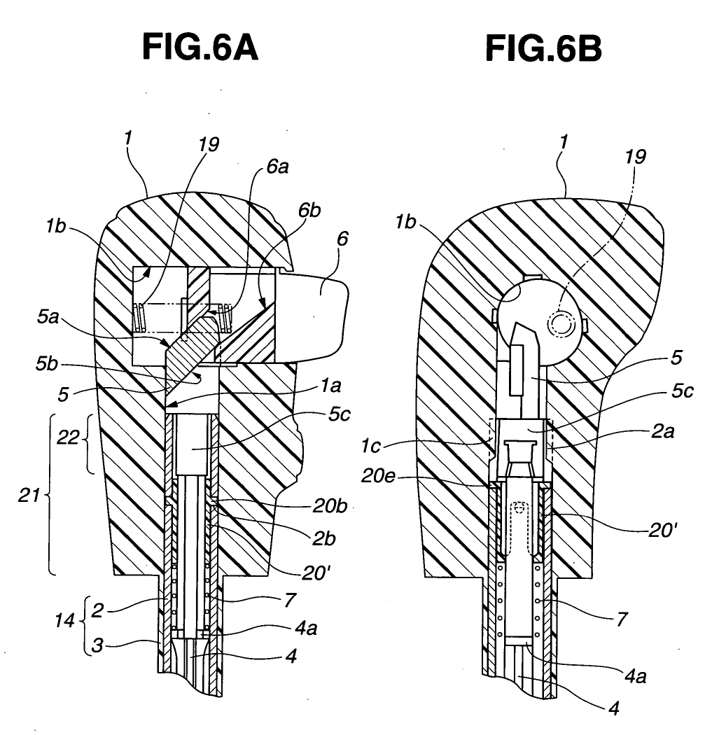

Referring to FIG. 6, the second embodiment will be described. In FIG. 6, like reference numeral designate like parts to those of the first embodiment and repeated description thereto is omitted for brevity.

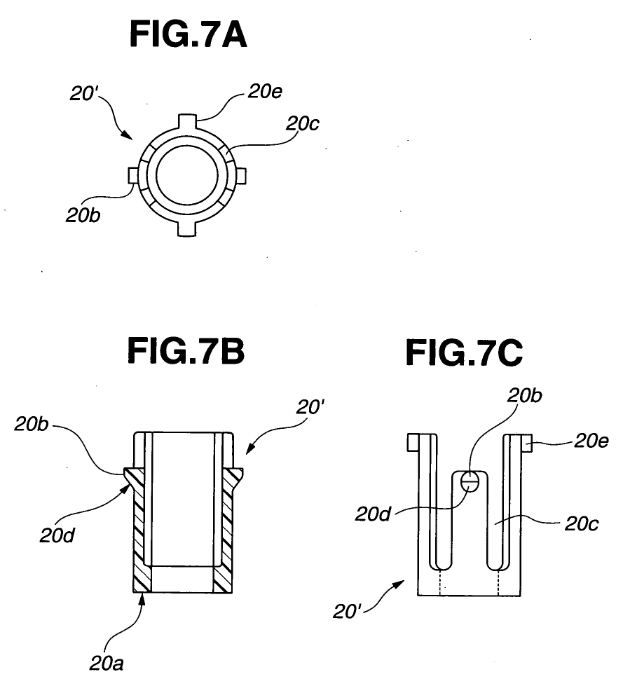

In the second embodiment, a spring support sleeve 20′ shown in FIG. 7 is used. As seen from FIG. 7, the spring support sleeve 20′ is larger in the overall length than that employed in the first embodiment. The spring support sleeve 20′ has at an outer circumferential surface a pair of projections 20e for preventing excessive insertion thereof into the tubular member 2. The projections 20e are diametrically opposite to each and located on a plane that is perpendicular to the plane on which the projections 20b are located. The projections 20e are adapted to be moved along while being engaged in the slits 2a of the tubular member 2 upon insertion of the spring support sleeve 20′ into the tubular member 2 as shown in FIG. 6B. The pair of holes 2b in which the pair of projections 20b are engaged differ in circumferential position by 90 degrees from those of the first embodiment, as will be understood from comparison of FIGS. 1 and 6.

By the present invention, the spring support sleeve 20′ is moved into the tubular member 2, with the projections 20e for preventing excessive insertion being circumferentially aligned with the respective slits 2a and moved along the same. Simultaneously with the projections 20b being engaged in the holes 2b, the projections 20e for preventing excessive insertion are abuttingly engaged with the inner ends of the slits 2a to prevent further insertion of the spring support sleeve 20′ into the tubular member 2. Thus, occurrence of such a case in which excessive insertion of the spring support sleeve 20′ that is performed even after the projections 20b are engaged in the holes 2b and causes the projections 20b from being disengaged from the holes 2b can be assuredly prevented and the assembly of the shift lever device can be attained with an improved efficiency and assuredness.

The entire contents of Japanese Patent Application P2005-120466 (filed Apr. 19, 2005) are incorporated herein by reference.

Although the invention has been described above by reference to a certain embodiment of the invention, the invention is not limited to the embodiment described above. Modifications and variations of the embodiment described above will occur to those skilled in the art, in light of the above teachings. For example, while in the second embodiment it has been described and shown that the projections 20e for preventing excessive insertion differ in the circumferential position by 90 degrees from the projections 20b and the holes 2b differ in the circumferential position by 90 degrees from the slits 2a, the projections 20e and the projections 20b may be formed at the same circumferential positions.

What is claimed is:

1. A shift lever device comprising:
a housing; and
a shift lever swingably supported on the housing;
the shift lever including:
a tubular member having a recessed portion at an inner circumferential surface;
a rod axially movably disposed in the tubular member and having a spring support portion;
a spring placed around the rod and abuttingly engaged at one of opposite ends with the spring support portion so as to urge the rod to lockingly engage at a lower end with the housing;
a knob connected to an end of the tubular member;
a knob button movably installed on the knob and operatively connected to the rod to cause, when pushed, the rod to be pulled upward against the bias of the spring thereby disengaging the rod from the housing to make the shift lever swingable; and
a spring support sleeve disposed within the tubular member for supporting the other of the opposite ends of the spring, the spring support sleeve having at an outer circumferential surface a projection that is engaged in the recessed portion of the tubular member.

2. A shift lever device according to claim 1, wherein the spring support sleeve has a spring support surface abuttingly engaged with the other of the opposite ends of the spring, the projection of the spring support sleeve being positioned closer to the knob than the spring support surface.

3. A shift lever device according to claim 1, wherein the tubular member includes an axial slit that is positioned closer to the knob than the recessed portion for guiding the projection of the spring support sleeve to the recessed portion.

4. A shift lever device according to claim 1, wherein the spring support sleeve includes a projection for preventing excessive insertion thereof into the tubular member, at a position closer to the knob than the projection engaged in the recessed portion, and the tubular member includes an axial slit that is positioned closer to the knob than the recessed portion and has an axial end with which the projection for preventing excessive insertion is abuttingly engaged.

5. A shift lever device for an automatic transmission of a vehicle comprising:
a housing fixed to a vehicle body; and
a shift lever swingably mounted on the housing;
the shift lever including:
a tubular member;
a rod axially movably disposed in the tubular member and having a spring support portion at an axially intermediate part thereof;
a spring support sleeve fixedly disposed in the tubular member and having a spring support surface at a lower end thereof;
a spring placed around the rod and between the spring support portion of the rod and the spring support surface of the spring support sleeve so as to urge the rod to lockingly engage at a lower end with the housing.

6. A shift lever device according to claim 5, further comprising a knob connected to an end of the tubular member, a knob button movably installed on the knob and operatively connected to the rod to cause, when pushed, the rod to be pulled upward against the bias of the spring thereby disengaging the rod from the housing to make the shift lever swingable.

7. A shift lever device according to claim 5, further comprising fixing means for fixing the spring support sleeve to the tubular member, the fixing means including a projection provided to the spring support sleeve and a recessed portion provided to the tubular member, the projection of the spring support sleeve being engaged in the recessed portion of the tubular member when the spring support sleeve is disposed in place within the tubular member.

8. A shift lever device according to claim 7, further comprising guide means for guiding the projection of the spring support sleeve into the recessed portion of the tubular member upon insertion of the spring support sleeve into the tubular member, the guide means including an axial slit provided to an upper end portion of the tubular member and located at the same circumferential position as the recessed portion.

9. A shift lever device according to claim 7, further comprising excessive insertion preventing means for preventing excessive insertion of the spring support sleeve into the tubular member, the excessive insertion preventing means including an axial slit provided to an upper end portion of the tubular member and a projection provided to an upper end portion of the spring support sleeve and abuttingly engaged with an axial end of the slit when the spring support sleeve is disposed in place within the tubular member.

10. A shift lever device according to claim 5, further comprising flexibility providing means for providing the spring support sleeve flexibility, the flexibility providing means including a plurality of axial slits provided to the spring support sleeve.
